(19) United States
(12) Patent Application Publication
(10) Pub. No.: US 2012/0096269 A1
(43) Pub. Date: Apr. 19, 2012

(54) DYNAMICALLY SCALABLE VIRTUAL GATEWAY APPLIANCE

(75) Inventor: Donald K. McAlister, Apex, NC (US)

(73) Assignee: Certes Networks, Inc., Pittsburgh, PA (US)

(21) Appl. No.: 13/274,202

(22) Filed: Oct. 14, 2011

Related U.S. Application Data
(60) Provisional application No. 61/393,159, filed on Oct. 14, 2010.

(51) Int. Cl. H04L 9/32

(52) U.S. Cl. 713/171

(57) ABSTRACT

A Virtual Elastic Gateway Appliance (VEGA) that implements all the capability of a security gateway in a set of virtual appliances for operation in a virtualized, cloud environment is provided. The virtual appliances are divided into various components to provide key exchange and data protection in separate virtual appliances allowing each to be scaled elastically and independently. Security management of the virtual gateway is under control of the client while the cloud provider can meter use of virtual resources. Shared state operation and tunneled key exchange ensure robust operation in a dynamic environment.

### RELATED APPLICATION

This application claims the benefit of U.S. Provisional Application No. 61/393,159, filed on Oct. 14, 2010.

The entire teachings of the above application are incorporated herein by reference.

### BACKGROUND

Computer systems operate in communication networks. Typically these networks include both local area networks (LAN) in a trusted location that allow direct addressing using local IP addresses and wide area networks (WAN) where connections may not be trusted and public IP addressing may be required. Traditionally, communicating from a system operating in a LAN, though the WAN, to another system in a separate LAN, involves addressing these two issues of security and address translation.

These issues can be addressed through the use of Virtual Private Networks (VPN). A VPN can be created by combining tunneling with encryption. Examples of VPN implementations are Internet Protocol Security (IPsec) and Secure Sockets Layer/Transport Layer Security (SSL/TLS) VPNs.

The device implementing the VPN technology at the edge of a network is the VPN gateway. The VPN connection can either be made between the edges of the LAN networks in a gateway to gateway VPN, or it can be made from an individual device within one LAN network to a gateway at the edge of the other LAN network in a remote access VPN. Implementation of the gateway can be either in hardware, either standalone or in a router or firewall appliance, or in software implemented on a server.

One limitation of VPN gateways is that the secure connections are typically point to point connections where the tunnel is defined by the IP address of the gateway and the encryption and authentication keys are negotiated in a key exchange, with Internet Key Exchange (IKE) or SSL/TLS, between the two gateways. The speed of traffic through the VPN is thus limited by the speed of the gateway. Further, the number of connections is limited by the gateway capability to perform key exchange.

The development of virtualized computing environments with virtual machines operating in a cloud infrastructure has exacerbated these limitations. In a virtualized environment, multiple computation stacks, including operating system, middleware, and applications, can operate together in a single server or set of servers. A cloud system is a virtualized environment where the virtual machines can elastically and dynamically scale to match the load or performance demands, where access to the cloud is through a public network, and where the number and capability of virtual machines can be metered by the cloud provider and made available to the specifications of the client using the cloud.

Access to the cloud network still requires secure tunnels as with hardware networks. To properly operate in a virtualized, cloud environment, the VPN gateway must be able to match the cloud requirements—elastic scaling to match load and performance demands, client management, and provider metering. In addition the security mechanisms of the gateway should be under control of the client to ensure isolation from other traffic into the cloud. Current gateway implementations fail to meet these requirements.

VPN gateways performing IKE/IPsec can operate with two or more devices to provide failover operation, but these fail to provide scaling to increase the number of available connections to all other LAN gateways or remote access devices for either traffic or key negotiation.

Software gateways running on servers as virtual appliances can operate in the cloud environment, but can only adjust to changes in load requirements by replicating the whole gateway, combining key exchange and data protection and using load balancing to distribute among the gateways.

The technology of load balancing to direct traffic to one of a number of servers providing duplicate capability is well known. Approaches that duplicate the security gateway are used in SSL connections and, to a lesser extent, in IKE/IPsec connections. Typically, these require the complete key negotiation and subsequent encryption to be managed by a single server for each inbound connection. As key negotiation and data protection are tied together on a single device, these are limited in their ability to handle a large volume of traffic from a single source. Conversely, approaches that require sharing of all key and negotiation material amongst a group of security gateways fail to scale to larger numbers as every step of every key negotiation must be accurately replicated to all devices. This leads to performance problems, negotiation failures and risk of denial of service attacks.

### SUMMARY

A. Recognition of Problems with Prior Art

In order to address the large traffic volume from a given client, current cloud providers are limited to the use of hardware security gateways that can manage the volume of encrypted data. This approach creates a number of limitations as shown in FIG. 1.

In FIG. 1, a prior art network 100 includes two clients, A 105 and B 110 connecting to one cloud provider 115 with two buildings, Bldg-1 120 and Bldg-2 125. Each client 105, 110 has a secure tunnel 130, 135 from the client gateway 140, 145 to the provider gateway 150. Unencrypted traffic then flows to each client's virtual machines 155, 160 through connections 165, 170. The problems with this arrangement are as follows:
Security parameters and unencrypted data for each client 105, 110 are shared on the gateway 150 resulting in a risk of compromising security.
The provider maintains control of security at the gateway 150 rather than allowing each client 105, 110 to control their own security. This also prevents the client 105, 110 from defining internal network segmentation without provider intervention.
If Client A 105 wants to host virtual machines 155, 195in the cloud 115, at two facilities, Bldg-1 120 and Bldg-2 125, the client must maintain separate secure tunnels 130, 175, and route traffic between the facilities 120, 125 through a client office. Similarly, if Client A 105 has multiple offices 180a, 180b, Client A 105 must all route traffic through the central office, via connection 185, to connect to the internal networks in the cloud 115. The foregoing requirements result in significant performance limitations and additional expense for the Client.
All access to the cloud 115 is through the physical gateways 150, 190 requiring duplication of hardware to scale to multiple clients. This increases cost and complexity for the provider.

U.S. Pat. No. 7,426,566, “Methods, systems and computer program products for security processing inbound communications in a cluster computing environment”, describes a system for IKE/IPsec whereby one server is used for IKE negotiation which then distributes the resulting Security Associations to multiple other endpoint servers. However, this solution relies on a dynamically routable Virtual Internet Protocol Address (DVIPA) that makes this approach unusable for providing a general connection on private networks across a public WAN and operating in a cloud environment as it forces a dependency on the endpoint devices as part of the solution. Various other U.S. patents also utilize custom operation of the routing protocol or routing table, such as U.S. Pat. Nos. 7,420,958, 7,116,665, and 6,594,704. U.S. Pat. No. 7,280,534 similarly uses an IP Service Controller to exchange addressing for a VPN on a Layer 2 network.

U.S. Pat. No. 7,743,155, “Active-active operation for a cluster of SSL virtual private network (VPN) devices with load distribution”, describes a system with a cluster of two or more nodes that receive a packet from a load balancing device, in which the load balancing device provides a virtual IP address for the cluster. The virtual connection can failover from one device to another through a dispatcher on each device. This approach fails to provide independent scalability of the key exchange from the encryption capability and does not provide elastic scalability to performance demands, and does not address operation in a virtualized computing or cloud computing environment. Furthermore, this approach is tied to a single virtual IP address and does not consider the issue of client controlled security.

U.S. Publication No. 2008/0104693, “Transporting keys between security protocols,” which is hereby incorporated by reference herein, describes placing the key exchange server on the local side of the data protection gateway and allowing the remote gateway to negotiate and send tunneled traffic to the local key server. The key server then performs negotiation and forwards the keys to the gateway which transparently performs encryption and decryption.

B. Solutions to These Problems.

Embodiments include a method and corresponding apparatus for providing a security gateway service in a virtualized computing environment. One example embodiment includes a number of virtual machines for protecting data sent to and from a client, called virtual data protection appliances (vDPA's) and a number of virtual machines for exchanging keys that are used to protect the client's data, called virtual key exchange appliances (vKEA's). At any one of the vDPA's, key exchange packets sent from a client are received. The receiving vDPA passes the key exchange packets to one of the vKEA's, referred to as a working vKEA.

The working vKEA performs the key exchange with the client by responding to the key exchange packets sent from the client. The working vKEA then distributes the result of the key exchange, including a key, to all of the vDPA's. Any one of the vDPA's protects the client's data using the distributed result of the key exchange.

The number of vDPA's or vKEA's or both is increased and decreased as the client's demand increases and decreases.

The embodiments described herein provide a unique solution for taking network data protection that requires point-to-point key exchange, and extending such protection to the demands of elasticity, client control, scaling, and virtualization demanded in cloud networking or virtualized environments.

In scenarios in which provider management of a cloud is independent of a client using the cloud, security is enhanced according to one embodiment by allowing the client to define policies and security parameters, such as certificates requiring private key material. The security is enhanced according to another embodiment by moving the vKEA to the client site.

Some of the described embodiments alleviate the management burden on the provider by restricting the provider's view (or involvement) to provisioning the configuration interface and metering the use of the virtual appliances. The provider is also relieved of the burden of maintaining separate physical hardware to provide clients with private networks in the cloud.

According to one embodiment, a client defines policy configurations, called client policy configuration, in which access to the virtual appliances in the cloud is isolated by network policies. This client policy configuration better matches current network security configurations and matches network segregation required by regulatory bodies, for example. This client policy configuration also allows for more stable deployments, connecting private virtual networks to multiple client offices or between provider buildings.

By using separate virtual appliances for data protection and key exchange, capabilities can be scaled independently and elastically. This separation of capabilities allows, for example, a client to only pay for the capability(s) required at a given time and for a given network. In another example, both virtual key exchange appliances and virtual data protection appliances can be duplicated, backed up, and moved as needed.

In one embodiment, critical state information of the key exchange and data protection virtual appliances are maintained. This state information can be replicated so that failure of any individual virtual appliance can be recovered by other virtual appliances with a minimal loss of traffic, and thus, improving provider and client operational availability.

The described embodiments offer a realistic solution to offering security gateway service in a virtualized computing environment that meets network performance requirements without, for example, overloading server computing time and resources. As further described below, encryption performance is independent of both server load and key exchange operations. Also described below, use of tunneled key exchange packets and shared state storage of key exchange messages and operations combine to provide a highly robust solution in a dynamic environment.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating the embodiments.

FIG. 1 is a network diagram of a prior art virtualized computing environment.

FIG. 2 is a network diagram of a virtualized computing environment in which a security gateway service is provided in accordance with various embodiments.

FIG. 3 is a block diagram of a virtual key exchange tunneling example.

FIGS. 4A and 4B are network diagrams of a virtualized computing environment in which security gateway service is provided according to an embodiment.

FIG. 5 is a network diagram of a re-encrypting embodiment.

FIG. 6 is a network diagram of a key exchange load balancing embodiment.

FIG. 7 is a network diagram of an embodiment in which a key exchange appliance is located at the client site.

FIG. 8 is a flow chart of an example procedure for providing a security gateway service in a virtualized computing environment.

FIG. 9 is block diagram of an example virtual security gateway to provide a security gateway service in a virtualized computing environment.

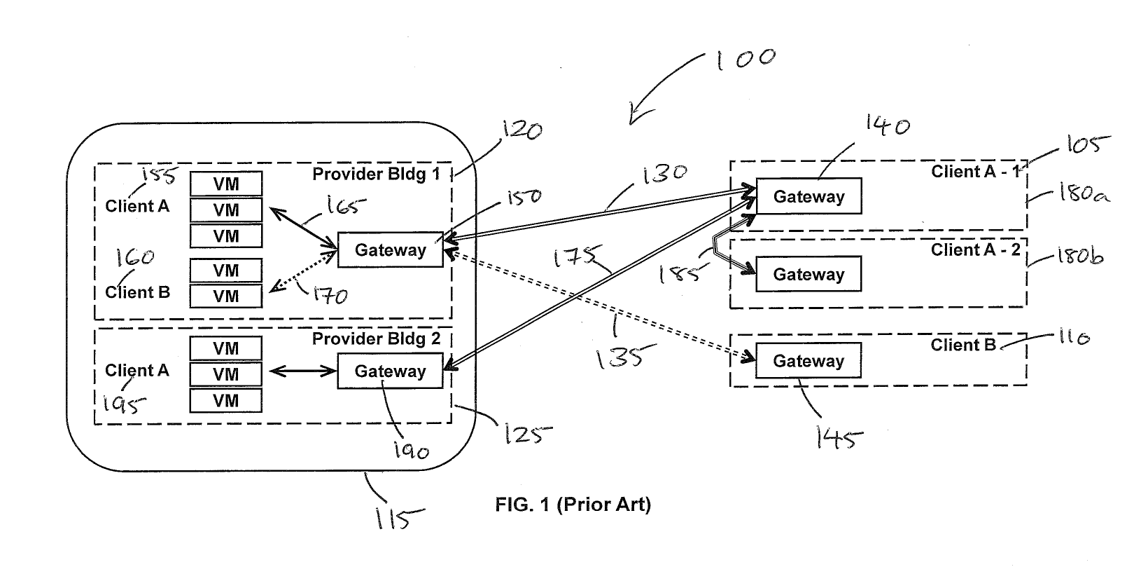

### DETAILED DESCRIPTION OF EXAMPLE EMBODIMENTS

A description of example embodiments follows.

The teachings of all patents, published applications, and references cited herein are incorporated by reference in their entirety.

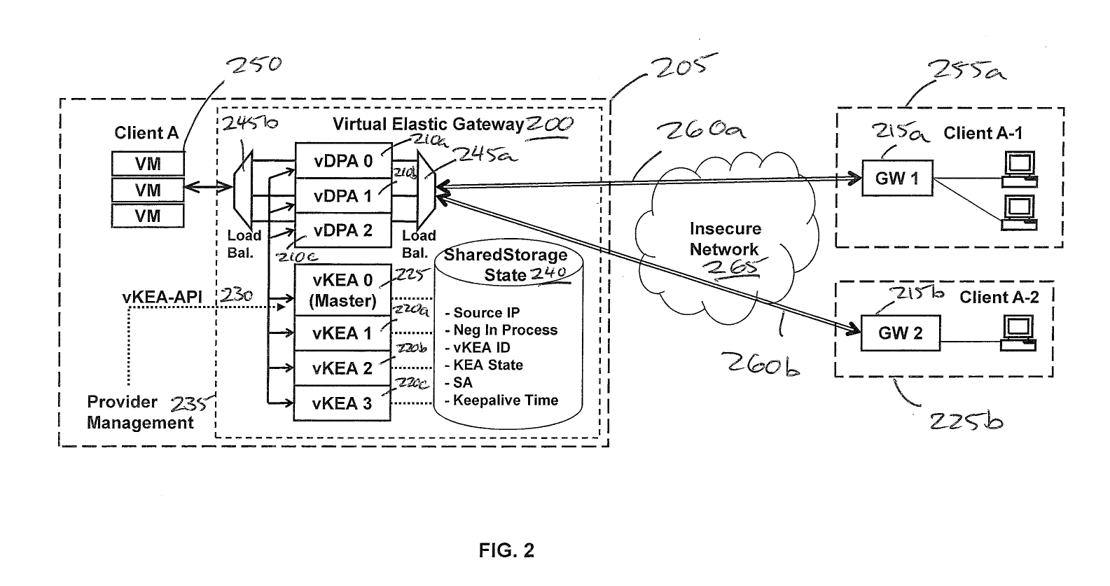

FIG. 2 shows the basic configuration of an example Virtual Elastic Gateway Appliance (VEGA) 205. In the example shown, VEGA 205 is providing an IKE/IPsec protocol-based solution. While features and functions of the example embodiment are presented below in the context of the IKE/IPsec protocol, these features and functions also apply to other protocols as well.

The VEGA 205 is made up of the following components implemented within the virtualized environment 205 of a provider cloud:
Virtual Data Protection Appliance (vDPA): The vDPA's 210a-c, generally 210, provide data protection functionality of the VEGA 205 including encryption/decryption and data integrity and source authentication. Data is protected from each of the vDPA's 210 to the client gateway (GW1, GW2) 215a, 215b.
Virtual Key Exchange Appliance (vKEA): The vKEA's 220a-c, generally 210, provides key exchange functionality with the client gateway 215a, 215b (which in this example is IKE). According to one embodiment, one of the vKEA's 220 acts as the master controller, called a Master vKEA 225. The Master vKEA 225 provides an application programming interface, called an vKEA-API 230, to external management 235 and monitors liveliness of other vKEA's 220.
Shared State Storage 240 provides transaction gated operations to key exchange state that may be shared between the vKEA's 220.
Load Balancers 245a, 245b provide load balancing to distribute both inbound and outbound traffic (e.g., key exchange packets and data packets) to the vDPA's 210.

FIG. 2 shows the cloud provider hosting a virtual infrastructure including virtual machines (VM's) 250 used by Client A. Client A is connecting to the VM's 250 from two sites, Client A-1 255a and Client A-2 255b, using standard IKE/IPsec gateways

GW1 215a and GW2 215b. The IKE/IPsec gateways GW1 215a and GW2 215b are located at client sites 255a, 255b. Traffic from the client sites 255a, 255b is encrypted in IPsec tunnels 260a, 260b that pass through an insecure network 265 to reach the provider site. The secure tunnels 260a, 260b are terminated by the VEGA 200, which provides key exchange and data protection as described below.

In one embodiment, data protection in each of the vDPA's 210 operates in software as a virtual machine. The inbound and outbound traffic go through a load balancer 245a that divides the traffic evenly between the vDPA's 210, for example, to minimize load to any one of the vDPA's 210. By increasing the number of vDPA's 210 and providing them with policies and keys for data protection, according to a convenient embodiment, increasing levels of network traffic can be handled.

Unlike current technologies, an embodiment separates the key negotiation function, IKE in this example, onto a separate virtual machine allowing the vKEA's 220 to dynamically increase (or decrease) in number allowing the key exchange operation to handle changing levels of key exchanges independent of network traffic.

Increasing/decreasing the number of vKEA's 220 independent of network traffic may be helpful, for example, if a large number of remote offices are connecting at the start of work day, requiring a large IKE negotiation load, but these offices do not produce heavy traffic until later in the day when markets opened.

A number of new components are implemented to perform the functionalities and capabilities described above.

Virtual Key Exchange Tunneling: Because key exchange traffic (e.g., IKE packets) from a client can be received at any arbitrary vDPA 210 and then forwarded to one particular vKEA 220 to accomplish the key exchange (or negotiation), in an example embodiment, the vDPA 210 creates a tunnel, called a Virtual Key Exchange Tunnel, with the targeted vKEA 220, encapsulating the key exchange packets. In addition, this tunnel also encapsulates packets that are not key exchange packets, but are required for performing key exchange (e.g., packets encrypted with an unknown key or unencrypted packets to a protected address). The Virtual Key Exchange Tunnel itself is capable of being encrypted to protect the key exchange packets.

Virtual Key Exchange Shared State Storage (or Shared State Storage): Key exchange mechanisms are stateful and include a series of messages that are exchanged, a sequence of operations that are performed, and shared keys that are derived from exchanged knowledge. The key exchange normally takes place between two specific devices, such as client gateway GW1 215a and vKEA2 220b. In one embodiment, the shared state storage 240 is used to coordinate key exchanges between the vKEA's 220 and client gateways, and to provide failover should one vKEA 220 be dynamically removed while that vKEA 220 is maintaining a key exchange. The shared state storage 240 also provides a mechanism for the Master vKEA 225 to verify liveliness of each of the vKEA's 220 and to coordinate policy updates.

Client Security Management: In separating the key exchange appliance from the data protection appliance and making both appliances virtual, this approach separates the provider configuration, deployment and metering of the VEGA 200 from the client task of configuring policy and security parameters. One embodiment allows the client to configure policies and security parameters, including certificates, in the vKEA's 220 either directly (e.g., from the client site 255a) or via the provider using the vKEA-API 230. In another embodiment, through the use of virtual key exchange tunneling (described above), the vKEA's 220 may be located away from the provider at the client's site.

Virtual Component Control: According to some embodiments, the Master vKEA 225 provides a unique combination of configuration and control. The Master vKEA 225 gives the provider an interface to launch the VEGA 200 and to set limits on a maximum number of vDPA's 210 and a maximum number of vKEA's 220, as well as, to limit their respective configuration. The Master vKEA 225 provides the interface for configuring security and policies either directly to the client or via the provider. The Master vKEA 225 also monitors the liveliness of the vKEA's 220 and manages changes in the number of vKEA's 220, vDPA's 210, their respective policies, and failure scenarios. In one embodiment, the Master vKEA 225 operates as a virtual machine with its state maintained in shared state storage 240. As such, the Master vKEA 225 can be moved or can failover with minimal impact to client traffic.

In one example, operation of the VEGA 200 begins with the provider deploying or provisioning the vDPA's 210 and the VKEA's 220, and, in one embodiment, the shared state storage 240. In a convenient embodiment, the Master vKEA 225 is used to configure public and internal IP addressing for the VEGA 200, as well as, default policies.

Once the VEGA 200 and its components are provisioned, the client configures security settings and policies for data protection and key exchange. In some embodiments, the client sets initial states for the vDPA and vKEA counts, sets the parameters for elasticity, and manages certificates on the vKEA's 220. In one embodiment, one or more of foregoing client activities are done through the Master vKEA 225 to which the client connects. The client configures the client's local gateways (e.g., gateways GW1, GW2 215a, 215b) independently.

After the VEGA 200 and its components are configured to perform key exchange and data protection, the key exchange, which in example below is IKE, and data protect are carried out as follows, according to one or more embodiments.
Initial IKE packet from GW1 215a:
   GW1 215a sends IKE init packet to VEGA 200. According to some embodiments, GW1 215a (client) sends key exchange packets without having access to information identifying that the packets are being received by a virtual machine that does not perform a key exchange.
   Load Balancer 1 245a forwards the IKE init packet to one of the vDPA's 210, in this example, vDPA1 210a.
   vDPA1 210a does not have GW1 215a in its cache, so vDPA 210a broadcasts a request for vKEA 220 supporting GW1. Alternately, vDPA 210a queries Master vKEA (vKEA0) 225.
   Each of the vKEA's 220 checks its respective cache. None of the vKEA's 220 have GW1 215a in cache, so none of the vKEA's 220 reply.
   Master vKEA (vKEA 0) 225 checks the shared state storage 240 and determines that GW1 215a is unassigned.
   vKEA0 225 creates an entry for GW1 215a in the shared state storage 240 and in this example, assigns GW1 215a to vKEA2 220b based on load or other criteria.
   vKEA0 225 notifies vKEA2 220b it has added a client.
   vKEA0 225 replies to vDPA1 210a with vKEA2 220b address.
   vDPA1 210a sends the IKE init packet to vKEA2 220b, e.g., by virtual key exchange tunneling the IKE init packet to VKEA2 220b according to one embodiment.
   vKEA2 220b looks up the GW1 table entry in the shared state storage 240, updates its local cache, and marks the table entry in the state storage 240 to ‘Neg In Process’ (negotiation in progress).
   vKEA2 220b initiates an IKE response with GW1 215a by sending an IKE response to GW1 215a.
Subsequent IKE packets from GW1 215a:
   Remember any of the vDPA's 210 may receive a key exchange packet. In other words, one vDPA does not necessarily receive all the packets exchanged during the life of the key exchange. In IKE example below, vDPA 210b receives the subsequent IKE packet from GW1 215a.
   vDPA2 210b does not have GW1 215a in cache, so vDPA 210b broadcasts a request for vKEA 220 supporting GW1 215a.
   vKEA2 220b replies that it supports GW1 215a.
   Other vKEAs do not have GW1 215a in cache and do not reply to the request.
   Master vKEA (vKEA0) 225 checks the shared state storage 240 and determines that GW1 215a is assigned to vKEA2 220b and vKEA2 220b is lively. vKEA0 225 does nothing.
   vDPA2 210b updates its cache and tunnels the packet to vKEA2 220b.
Completion of IKE with GW1 215a:
   At end of Phase 2 of IKE, vKEA2 220b loads the IKE state and Security Association (SA) to the table entry of the shared state storage 240 and clears ‘Neg In Process’ from the table entry of the shared state storage 240
   vKEA2 220b sends final IKE packet to GW1 215a
   vKEA2 220b initiates internal timers for rekey, dead peer detection (if necessary) and table liveliness update

After performing the key exchange, a result of the key exchange (which in the IKE example above, is a Security Association (SA) containing one or more derived keys) is installed on each of the vDPA's 210. In one embodiment, the result of key exchange is installed on each of the vDPA's 210 with a unicast message or broadcast message to all vDPA's 210 to install. In another embodiment, a vDPA (e.g., vDPA0 210a) can request the result of the key exchange from the vKEA2 220b upon discovering that the result is needed as follows.

Upon receiving at vDPA 210a, an initial outbound data packet from VM 250 to Client A-1 without SA or inbound data packet from Client A-1 with unknown SPI:
vDPA0 210a broadcasts a request for vKEA 220 for GW1 215a if not in cache and receives a reply from vKEA2 220b.
vDPA0 210a requests GW1 SAs. vKEA2 220b replies with the SAs.
   NOTE: Another approach may be for vDPA0 210a to query the shared state storage 240 directly for the SAs.
   In any approach, if the results of the key exchange, such as the keys, are expired or unavailable, a query for vKEA 220 is made and the problem packet is forwarded to vKEA2 220b for processing (e.g., by starting a new IKE Phase 2).

According to another convenient embodiment, the VEGA 200 performs periodic operations to ensure re-keys are done in a timely manner, expired keys are removed, and a failure in any one of the vKEA's 220 do not result in system failure.
Liveliness, Dead Peer, and Rekey Operations:
   On a periodic basis, vKEA2 220b, in this example, will perform scheduled operations (in the example context of IKE).
      vKEA2 220b retrieves the IKE state entry (e.g., from the shared state storage 240), verify it is still owner of each policy in cache, and update a Keepalive Timer.
      If Dead Peer Detection (DPD) is enabled, vKEA2 220b will check if a KAP (“Key Authority Point”) is scheduled, send it, and update the state.
         Note: DPD will not be able to check traffic in this approach unless the vDPA's 210 update the shared state storage 240.
      The state will be checked to see if rekeys are scheduled and initiate the rekeys if necessary.
         Note: In one embodiment, only clients initiate rekeys.
      If the vKEA2 220b determines that the policy has expired (e.g., DPD timeout), then the vKEA2 220b:
         Removes the state entry (e.g., from the shared state storage 240) and clear its own cache
         Refuses further IKE packets from GW1 215a until notified by the Master vKEA 225 it has been reassigned vKEA1 220a.
            This refusal propagates the removal to each of the vDPA's 210.
            This refusal can also be done with a broadcast to all of the vDPA's 210or unicast to each of the vDPA's 210.
   On a periodic basis, the Master vKEA (vKEA0) 225 queries the shared state storage 240 for liveliness of each table entry.
      If an entry is expired, the Master vKEA (vKEA0) 225 queries the vKEA's it is assigned, removes the entry from the active list if needed, reassigns GW1 215a to another vKEA, updates the state entry, and notifies the new vKEA.
      The expired vKEA is queried regularly for liveliness. If the expired vKEA returns, the expired vKEA is notified to clear its cache.

In the description above, reference is made to the tunneling of IKE traffic (and other related packets) from the vDPA's 210 to the vKEA's 220.

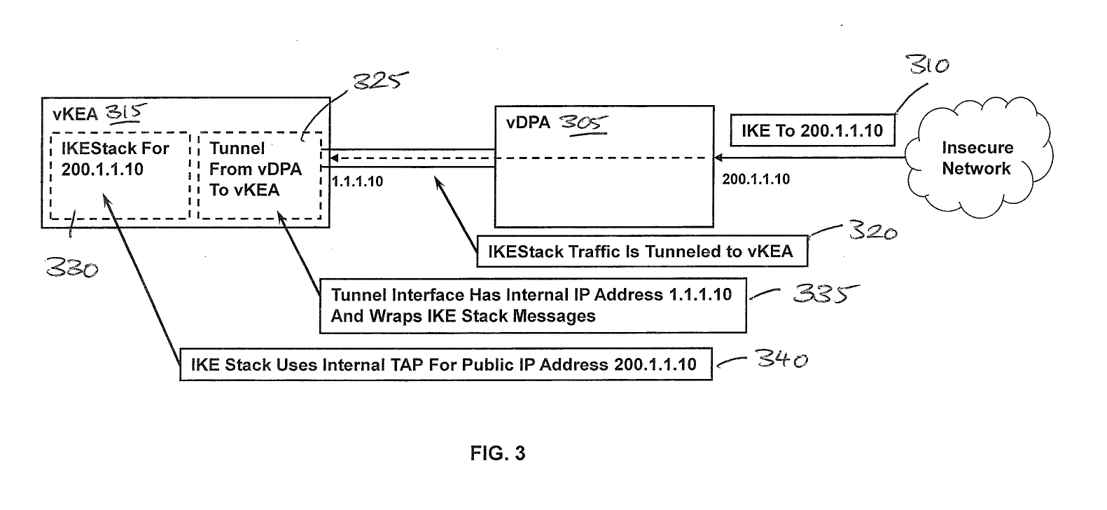

FIG. 3 shows one example of virtual key exchange tunneling (using IKE as an example) in which each of the vDPA's of an example VEGA, one of which is shown, vDPA 305, can encapsulate a key exchange packet 310 (and other related packets) targeted for vKEA 315, using the actual address of the individual vKEA in the outer header (represented by block 320). The vKEA 315 maintains a network shim 325 that captures the encapsulated packet, strips the encapsulation, and forwards the de-encapsulation packet (represented as block 335) to IKE stack 330. The reverse is done on outbound packets.

In this example of virtual key exchange tunneling, the IKE stack 330 operates with multiple IP addresses not actually configured on the virtual machine interface (represented as block 340).

The above embodiments are described as an IKE/IPsec solution but there are a number of different scenarios to which these embodiments may be used. For example, a VEGA, according to one or more embodiments, can provide gateway protection using Secure Socket Layer (SSL) or Transport Layer Security (TLS) protection by performing key exchange in one set of virtual appliances and data protection in another set of virtual appliances. In this example, in addition to forwarding key exchange packets from vDPA's though a tunnel, packets maintaining TCP connectivity are also forwarded.

One approach according to one or more embodiments described above can be used with any protocol that requires key exchange or authentication, normally performed in a point-to-point fashion, with data protection where scalability and elasticity are required.

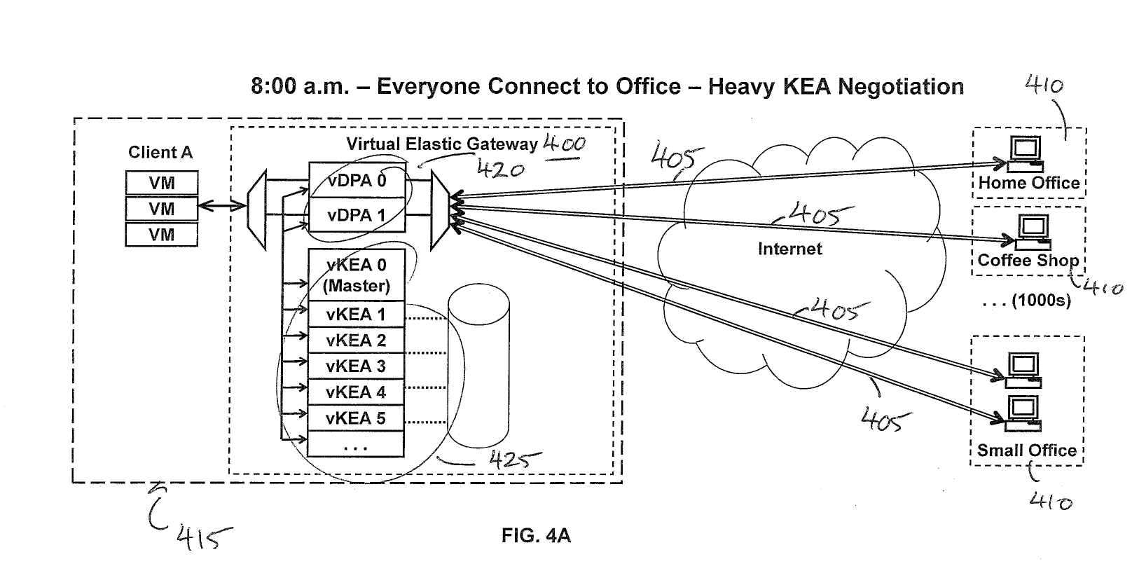

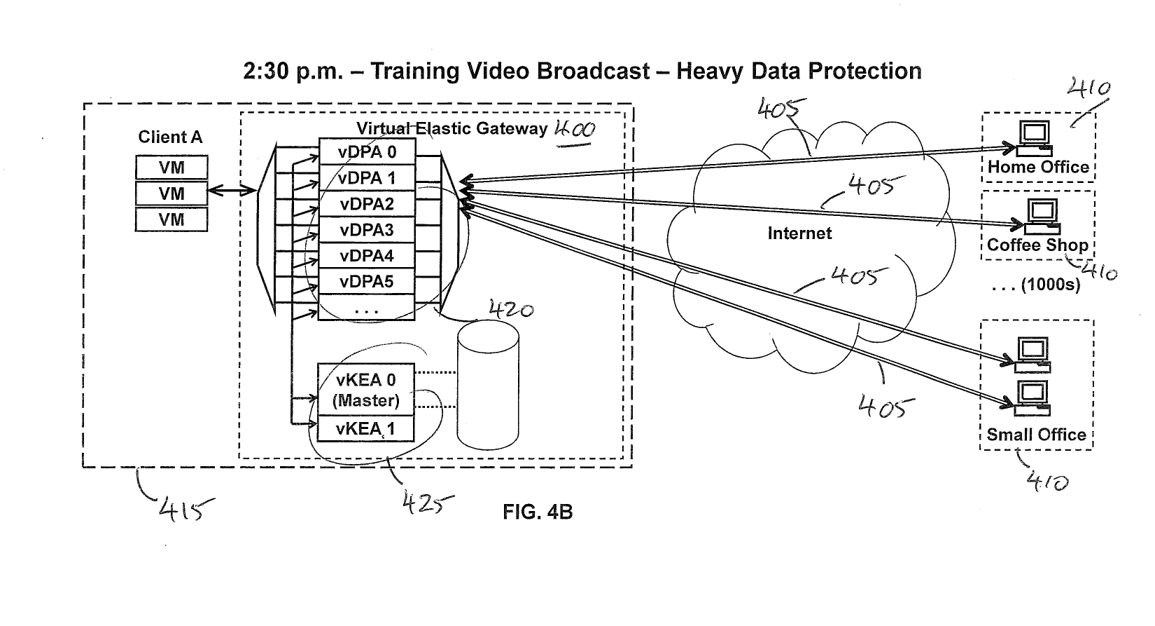

FIGS. 4A and 4B show another embodiment in which connections 405 are from an individual computer, server, workstation, mobile device, or other like client device, generally 410, and not from a gateway protecting a subnet (as shown in FIG. 2). In this scenario, each of the client devices 410 is operating as a remote access device. Each of the client devices 410 connects a single Internet Protocol (IP) address to a virtual network or cloud 415. A VEGA 400, according to one embodiment, provides a unique solution to this remote access scenario as there are likely to be a large number of remote access connections 405, each of which requires key negotiation that is computationally intensive. Network traffic demands, though, may be higher or lower than the demands of the key negotiation. By offering independent scaling and elasticity for the network traffic demands and demands of key negotiation, the VEGA 400 can adjust dynamically to the specific demands.

FIG. 4A shows that during periods of heavy key exchange demands, such as the start of the workday, a number of virtual key exchange appliances (vKEA's) 425 increases while fewer virtual data protection appliances (vDPA's) 420 are required.

FIG. 4B shows that during periods of heavy data protection demands, such as during broadcast of a corporate training video, the number of vDPA's 420 increases while fewer vKEA's 425 are required. According to one embodiment, though a number of vKEA's 425 are removed, there is no loss of key negotiation state and there is no need for mass renegotiation because of the shared state storage mechanism and key exchange tunneling, as described above in reference to FIG. 2.

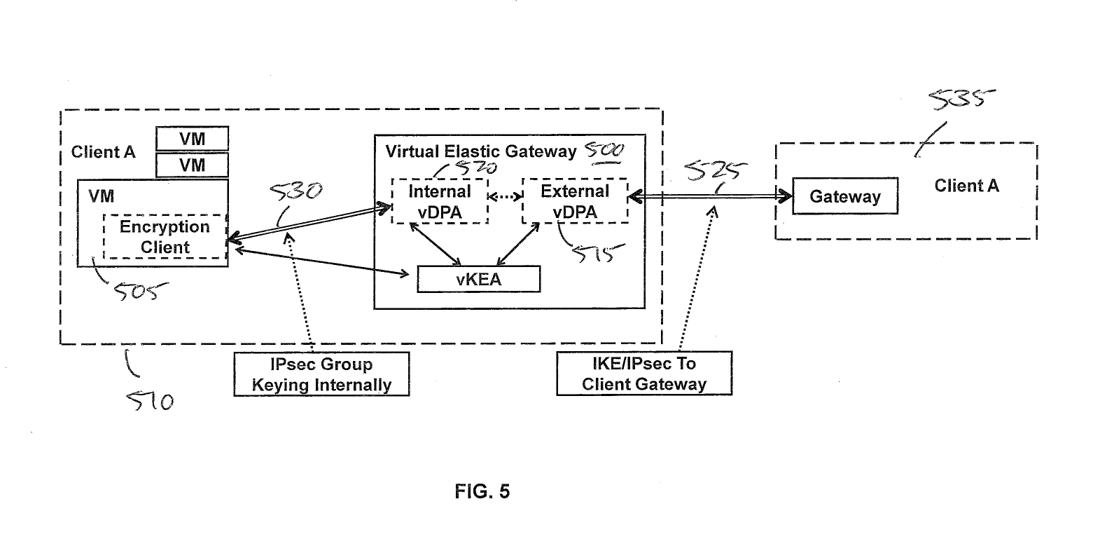

FIG. 5 shows an example VEGA 500 that according to one embodiment provides protection to a client virtual machine 505 inside of a provider cloud 510 while still using a single public IP address. In this embodiment, an external vDPA 515 and internal vDPA 520 act as a Re-encrypting Policy Enforcement Point, as described in Patent Application 2008/0072033, which is incorporated by reference herein in its entirety. In this re-encrypting embodiment, the VEGA 500 establishes encryption tunnels (data protection tunnels) 525 with a client 535 as described above. In addition, the internal vDPA 520 establishes data protection tunnels 530 internal to the provider cloud 510 to (individual) client virtual machines 505. The external vDPA 515 then decrypts inbound data packets from the client 535 and the internal vDPA 520 re-encrypts the decrypted inbound data packets sent to the (individual) client virtual machines 505.

In another embodiment, the internal vDPA 520 re-encrypts decrypted data packets that are sent to a gateway or other remote access device located outside of the provider cloud 510. In this embodiment, another data protection tunnel (not shown) is established with the external gateway or other remote access that is in addition to the data protection tunnel 525 with the client 525. This external type of re-encrypting may be used to protect traffic between multiple client sites, e.g., Client A-1 255a and Client A-2 255b of FIG. 2. In FIG. 2, either GW1 215a or GW2 215b can be considered the external gateway of the foregoing embodiment.

The protection policies, encryption types, and even network types need not be the same on each side of the vDPA's 515, 520. For example, the external encryption tunnel (or connection) 525 might be encrypted with SSL/TLS while the internal encryption tunnel (or connection) 530 is protected with IPsec.

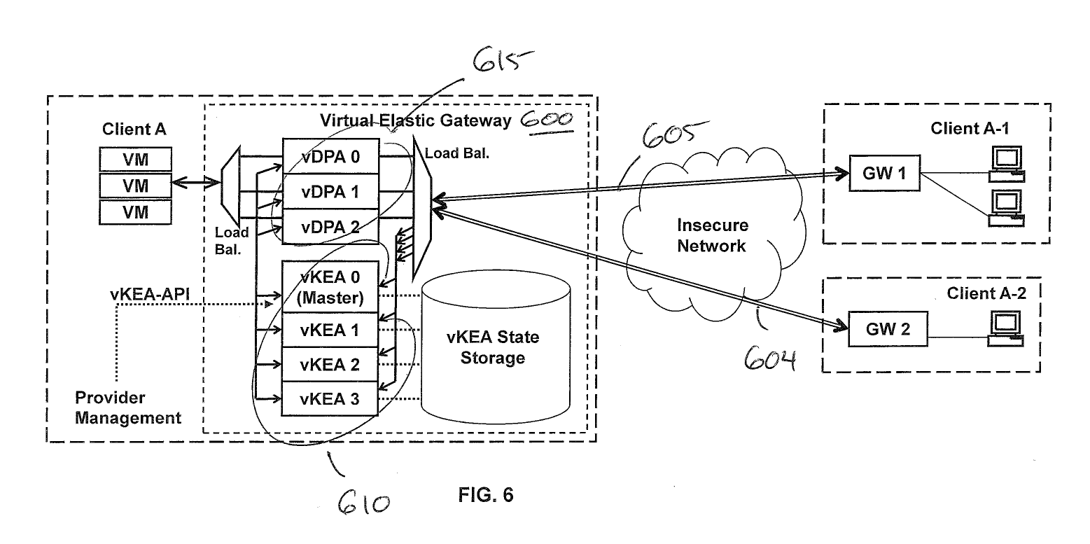

FIG. 6 shows an alternate configuration of a VEGA 600 in accordance with one embodiment, in which key exchange transactions (represented in FIG. 6 as double-ended arrow lines 605) are directly load balanced to vKEA's 610 to limit the tunneling requirements of vDPA's 615.

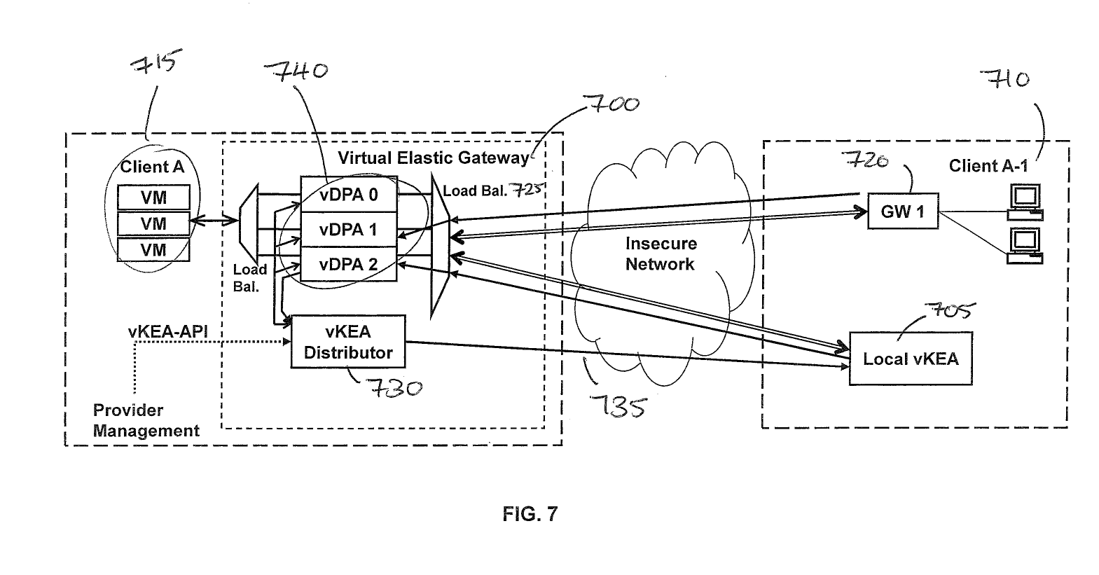

FIG. 7 shows another configuration of a VEGA 700 in accordance with another embodiment, in which a vKEA 705 is placed at local client location 710 (labeled in FIG. 7 as “Local vKEA”). This placement of the Local vKEA 705 allows all critical, non-dynamic security components to be maintained in the local client location 710 (e.g., policy definition and certificates) while providing elastic and scalable encryption operations at remote cloud site 715. In addition, at no time is decrypted key exchange or negotiation packets exposed in the cloud environment 715.

In foregoing approach, Client GW-1 720 initiates a key exchange to public IP address in the cloud 715 at a VEGA load balancer 725. A key exchange packet is forwarded to a vKEA distributer 730. The vKEA distributer 730 then sends the key exchange packet in a tunnel 735 to the Local vKEA 705.

The Local vKEA 705 continues the key exchange, tunneling back through the cloud 715 to the vKEA Distributor 730, which sends the key exchange packet back to the original GW-1 720. When the exchange is complete, the Local vKEA 705 sends the keys (and/or security associations) to the vKEA Distributer 730, which installs the keys in each of the vDPA's 740.

FIG. 7 shows the alternate configuration with a single Local vKEA, the Local vKEA 705. This configuration, however, can be equally performed with a collection of virtualized key exchange appliances through a load balancer at the local client location 710, as described above in reference to FIG. 2.

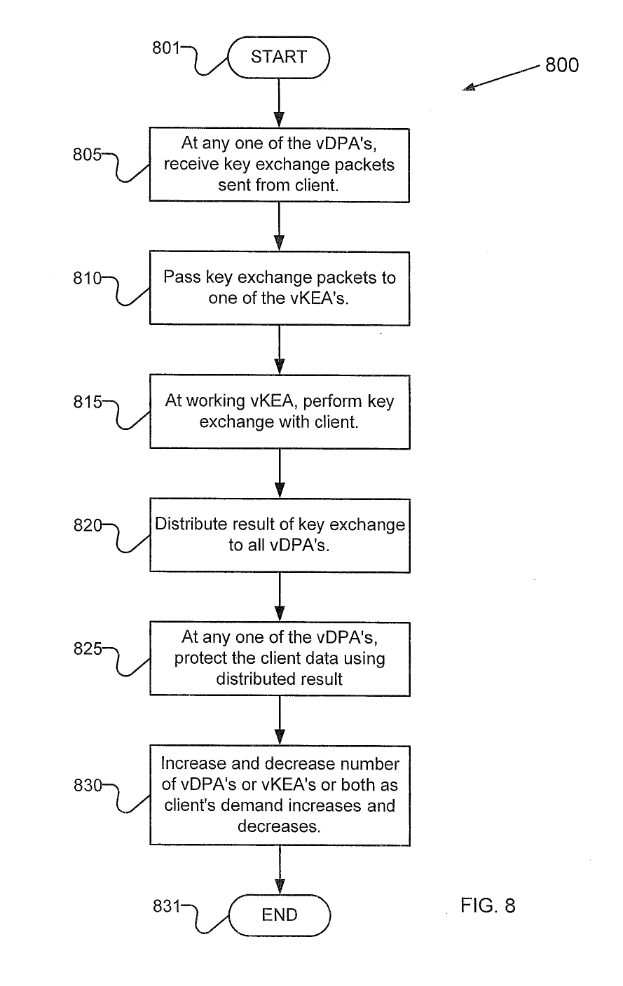

FIG. 8 shows an example procedure 800 for providing a security gateway service in a virtualized computing (or cloud computing) environment. The procedure 800 may performed by a virtual security gateway, such as the Virtual Elastic Gateway Appliance (VEGA) 205 of FIG. 2. As such, while the steps of the procedure 800 are described below in terms of the procedure 800 carrying out these steps, in one embodiment, it is the virtual security gateway, or more specifically, the virtual machines for protecting data sent to and from a client (vDPA's) and the virtual machines for exchanging keys that are used to protect the client's data (vKEA's) of a network device—a particular machine—that performs these steps.

The procedure 800 starts at 801. The procedure 800, at any one of the vDPA's, receives (805) key exchange packets sent from the client. The packets being received (805) are sent from a client that has no access to information identifying that the key exchange packets are being received by a virtual machine that does not perform a key exchange. The procedure 800 then passes (810) the key exchange packets to one of the vKEA's. The vKEA to which the key exchange packets are being passed is referred to as a working vKEA.

The procedure 800, at the working vKEA, performs (815) the key exchange with the client by responding to the key exchange packets sent from the client. The procedure 800 then distributes (820) the result of the key exchange including a key to all of the vDPA's.

The procedure 800, at any one of the vDPA's, protects (825) the client's data using the distributed result of the key exchange.

The procedure 800 increases and decreases (830) the number of vDPA's or vKEA's or both as the client's demand increases and decreases.

The procedure 800 ends at 831.

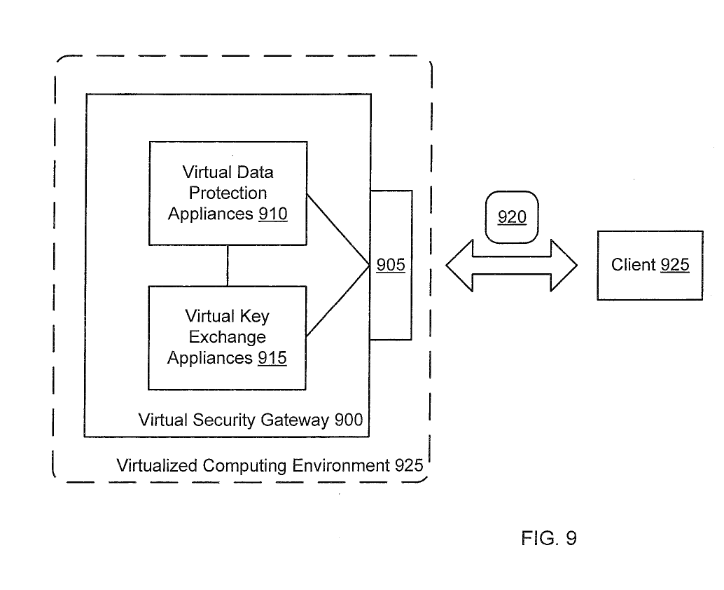

FIG. 9 shows an example virtual security gateway 900 to provide security gateway service in a virtualized computing (or cloud computing) environment. The gateway 900 includes a network interface 905, a number of virtualized processors performing data protection (vDPA's) 910, and a number of virtualized processors performing key exchanges (vKEA's) 915. The network interface 905, vDPA's 910, and vKEA's 915 are each communicatively coupled to one another as shown.

The network interface 905 is configured to send and receive packets 920 (e.g., key exchange packets and data packets) to and from a client 925. The vDPA's 910 and vKEA's 915 are configured to perform the procedure 800 of FIG. 8 and procedures according to other embodiments (e.g., the procedures described in reference to FIG. 2).

It should be understood that the example embodiments described above may be implemented in many different ways. In some instances, the various “machines” and/or “data processors” described herein may each be implemented by a physical, virtual or hybrid general purpose computer having a central processor, memory, disk or other mass storage, communication interface(s), input/output (I/O) device(s), and other peripherals. The general purpose computer is transformed into the machines described above, for example, by loading software instructions into a data processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The data processors that execute the functions described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein constitute a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the data processors described herein are intended for purposes of illustration only and not as a limitation of the embodiments.

While the embodiments have been particularly shown and described with references to examples thereof, it will be understood by those skilled in the art that various changes in form and details may be made therein without departing from the scope encompassed by the appended claims.

What is claimed is:

1. A method comprising:
in a virtualized computing environment in which a shared pool of configurable computing resources is provided, over a network, to disparate clients as a service, the resources being provided include a number of virtual machines for protecting data sent to and from a client, called virtual data protection appliances (vDPA's) and a number of virtual machines for exchanging keys that are used to protect the client's data, called virtual key exchange appliances (vKEA's);
at any one of the vDPA's, receiving key exchange packets sent from the client;
passing the key exchange packets to one of the vKEA's, the one vKEA being referred to as a working vKEA;
at the working vKEA, performing the key exchange with the client by responding to the key exchange packets;
distributing the result of the key exchange including a key to all of the vDPA's;
at any one of the vDPA's, protecting the client's data using the distributed result of the key exchange; and
increasing and decreasing the number of vDPA's or vKEA's or both as the client's demand increases and decreases.

2. The method of claim 1 wherein the key exchange is being performed in accordance with the Internet Key Exchange (IKE) protocol;
wherein the result of the key exchange is a Security Association (SA); and
wherein the client's data is being protected in accordance with the Internet Protocol Security (IPsec) protocol.

3. The method of claim 1 wherein receiving the key exchange packets includes load balancing receipt of the key exchange packets among the vDPA's.

4. The method of claim 1 wherein the key exchange packets that being received are sent from the client without the client having access to information identifying that the key exchange packets are being received by a virtual machine that does not perform a key exchange.

5. The method of claim 1 wherein passing the key exchange packets includes tunneling the key exchange packets to the working vKEA.

6. The method of claim 5 wherein tunneling the key exchange packets includes encapsulating the key exchange packets inside of Internet Protocol (IP) tunnel packets having outer headers with the IP address of the working vKEA.

7. The method of claim 1 wherein the key exchange is being performed in accordance with a point-to-point key exchange protocol including any one of Internet Key Exchange (IKE), Secure Sockets Layer (SSL), and Transport Layer Security (TLS).

8. The method of claim 1 wherein protecting the client's data includes at any one of the vDPA's,
establishing a data protection tunnel to the client;
encrypting data sent to the client through the data protection tunnel;
decrypting encrypted data sent from the client through the data protection;
verifying the integrity of data sent to and from the client through the data protection; and
authenticating the source of data.

9. The method of claim 8 further comprising:
at another one of the vDPA's, establishing another data protection tunnel to one or more computing resources being provided to the client including other virtual machines;
re-encrypting data sent from the client that has been decrypted by one of the vDPA's; and
sending the re-encrypted data to the one or more computing resources through the other data protection tunnel.

10. The method of claim 8 further comprising:
at another one of the vDPA's, establishing another data protection tunnel to a gateway or remote access device located external to the virtualized computing environment;
re-encrypting data sent from the client that has been decrypted by one of the vDPA's; and
sending the re-encrypted data to the external gateway or remote access device through the other data protection tunnel.

11. The method of claim 9 wherein the data protection tunnel is being established according to a first network security protocol and the other data protection tunnel is being established according to a second network security protocol, and wherein the first and second network security protocols is any one of Internet Protocol Security (IPsec), Secure Sockets Layer (SSL), and Transport Layer Security (TLS) protocols.

12. The method of claim 8 wherein the other data protection tunnel is being established using a key that is distributed to the vDPA's according to a group policy.

13. The method of claim 1 wherein distributing the results of the key exchange includes any one of unicasting the results to each of the vDPA's and broadcasting the results to all of the vDPA's.

14. The method of claim 1 wherein a maximum number of vDPA's and maximum number of vKEA's is configured by a provider of the virtualized computing environment.

15. The method of claim 1 wherein the key exchange is being performed and the client's data is being protected in accordance with security and policy parameters configured by the client.

16. The method of claim 1 further comprising:
storing information about the key exchange including a series of messages exchanged and sequence of operations performed;
coordinating which of the vKEA' is the working vKEA to perform the key exchange using the information being stored; and
when the working vKEA is removed while the working vKEA is maintaining the key exchange, failing over to another vKEA and continue maintaining, at the other vKEA, the key exchange using the information being stored.

17. The method of claim 1 further comprising:
given one of the vKEA, called a master vKEA;
at the master vKEA, in response to the key exchange being received from the client, selecting one of the vKEA to be the working vKEA that performs the key exchange with the client.

18. The method of claim 17 wherein selecting the working vKEA includes identifying a vKEA assigned to the client.

19. The method of claim 1 further comprising providing a single interface to the vDPA's that logically represents all of the vKEA's.

20. The method of claim 19 wherein providing the single interface includes each of the vKEA's storing a respective result of a corresponding key exchange in a shared state storage that is accessible to all of the vDPA's.

21. A method comprising:
in a virtualized computing environment in which a shared pool of configurable computing resources is provided, over a network, to disparate clients as a service, at a network device running a number of virtual machines for protecting data sent to and from a client, called virtual data protection appliances (vDPA's) and a number of virtual machines for exchanging keys that are used to protect the client's data, called virtual key exchange appliances (vKEA's);
at any one of the vDPA's of the network device, receiving key exchange packets sent from the client;
passing the key exchange packets to one of the vKEA's of the network device, the one vKEA being referred to as a working vKEA;
at the working vKEA, performing the key exchange with the client by responding to the key exchange packets;
distributing the result of the key exchange including a key to all of the vDPA's;
at any one of the vDPA's, protecting the client's data using the distributed result of the key exchange; and
increasing and decreasing the number of vDPA's or vKEA's or both as the client's demand increases and decreases.

22. A virtual elastic security gateway comprising:
a network interface for sending and receiving packets to and from a client in a virtualized computing environment in which a shared pool of configurable computing resources is provided, over a network, to disparate clients as a service;
a number of virtualized processors performing data protection, called virtual data protection appliances (vDPA's), communicatively coupled to the network interface;
a number of virtualized processors performing key exchanges that are used to protect the client's data, called virtual key exchange appliances (vKEA's), communicatively coupled to the network interface and the vDPA's;
wherein each of the vDPA's is configured to:
receive, through the network interface, key exchange packets sent from the client;
pass the key exchange packets to one of the vKEA's, the one vKEA being referred to as a working vKEA;
protect the client's data using a result of the key exchange distributed to the vDPA's;
wherein each of the vKEA's is configured to:
perform as the working vKEA and exchange keys with the client by responding, through the network interface, to the key exchange packets;
distribute the result of the key exchange including a key to all of the vDPA's; and
wherein the number of vDPA's or vKEA's or both are increased and decreases as the client's demand increases and decreases.

23. The virtual elastic security gateway of claim 22 further comprising a load balancer communicatively coupled to the network interface and the vDPA's to load balance receipt of the key exchange packets among the vDPA's.

24. The virtual elastic security gateway of claim 22 further comprising a shared state storage communicatively coupled to the vKEA to store information about the key exchange including a series of messages exchanged and sequence of operations performed.

25. A computer program product including a non-transitory computer readable medium having a computer readable program, the computer readable program when executed by a computer, transforms the computer into a programmed computer and causes the programmed computer to:
virtualize a computer processor into a number of virtualized processors performing data protection, called virtual data protection appliances (vDPA's) and into a number of virtualized processors performing key exchanges that are used to protect the client's data, called virtual key exchange appliances (vKEA's);
increase and decrease the number of vDPA's or vKEA's or both as the client's demand increases and decreases;
wherein the vDPA's and vKEA's are being provided in a virtualized computing environment in which to a shared pool of configurable computing resources is provided, over a network, to disparate clients as a service;
wherein each of the vDPA's is configured to:
receive key exchange packets sent from the client;
pass the key exchange packets to one of the vKEA's, the one being referred to as a working vKEA;
protect the client's data using a result of the key exchange distributed to the vDPA's;
wherein each of the vKEA's configured to:
perform as the working vKEA and exchange keys with the client by responding to the key exchange packets sent from the client; and
distribute the result of the key exchange including a key to all of the vDPA's.
